(19) United States
(12) Patent Application Publication
(10) Pub. No.: US 2018/0153152 A1
(43) Pub. Date: Jun. 7, 2018

(54) Horseshoe

(71) Applicant: Lesley Richard Collier, Abbotsford (CA)

(72) Inventor: Lesley Richard Collier, Abbotsford (CA)

(21) Appl. No.: 15/410,573

(22) Filed: Jan. 19, 2017

Related U.S. Application Data
(60) Provisional application No. 62/280,826, filed on Jan. 20, 2016.

(51) Int. Cl. A01L 1/04; A01L 5/00

(52) U.S. Cl. CPC A01L 1/04; A01L 5/00

(57) ABSTRACT

The present invention relates to a horseshoe having a toe end, a heel end opposite the toe end, a top surface that spans between the heel end and the toe end, and a bottom surface that spans between the heel end and the toe end, wherein the top surface tapers toward the bottom surface from the heel end to the toe end.

### CROSS REFERENCE TO RELATED APPLICATIONS

This application claims priority from U.S. Provisional Patent Application Ser. No. U.S. 62/280,826 filed on Jan. 20, 2016, entitled HORSESHOE, which is expressly incorporated by reference herein to the fullest extent permitted by law.

### BACKGROUND

### 1. Field

The present invention relates to shoes for horses, and in particular shoes that address traction, durability and health.

### 2. Description of Related Art

Shoes for horses balance a number of criteria, including:
providing traction appropriate for the environment in which they are used,
protecting a horse against injury or further injury, both acute and chronic, by providing appropriate support and absorbing shock, and
providing suitable durability.

### SUMMARY

The present invention is directed to this need.

According to one aspect of the invention, there is provided an apparatus operable as a horseshoe, having: a toe end, a heel end opposite the toe end, a top surface that spans between the heel end and the toe end, and a bottom surface that spans between the heel end and the toe end, wherein the top surface tapers toward the bottom surface from the heel end to the toe end.

The separation between the top surface and the bottom surface at the heel end may be 1″. The taper may be ⅛″.

The top surface may enclose a void between the heel end and the toe end.

There may be a reinforcing crossbar. The crossbar may be located at the heel end or located between the toe end and the heal end and may divide the void.

The bottom surface may be a peripheral flange. The peripheral flange may be closed. The peripheral flange may include a spur at the heel end. The width of the peripheral flange may taper from the heel end to the toe end; the width of the peripheral flange may taper from ¾″ at the heel end to ⅛″ at the toe end. The peripheral flange may be notched at the toe end.

There may be a sprung lever extending downward from the toe end to the heel end within the peripheral flange.

There may be a toe flange extending vertically from the toe end. The toe flange may extend upward and be adapted to receive a hoof. The toe flange may extend downward and be adapted to engage the ground.

The bottom surface may be cambered at the toe end.

The apparatus may be formed from at least one of magnesium, tempered aluminum, and plastic. In this regard, the plastic may be at least one of: toluene diisocyanate (TDI) poly tetramethylene ether glycol (PTMEG) prepolymer 80 Shore A, and toluene diisocyanate (TDI) poly tetramethylene ether glycol (PTMEG) prepolymer 75 Shore D.

The apparatus may be formed as a lamination of layers, for example as a lamination of a top layer, at least one middle layer and a bottom layer, each layer extending between the heel end and the toe end. The top layer may be adapted to support a hoof. The at least one middle layer may be adapted to accept and retain nails. The bottom layer may be adapted to engage the ground. The top and bottom layers may be elastically compressible between 25 and 35 percent. The top layer may be ⅛ inch thick; the at least one middle layer may be ⅜ inch; the bottom layer may be ½ inch thick.

Further aspects and advantages of the present invention will become apparent upon considering the following drawings, description, and claims.

### DESCRIPTION

The invention will be more fully illustrated by the following detailed description of non-limiting specific embodiments in conjunction with the accompanying drawing figures. In the figures, similar elements and/or features may have the same reference label. Further, various elements of the same type may be distinguished by following the reference label with a second label that distinguishes among the similar elements. If only the first reference label is identified in a particular passage of the detailed description, then that passage describes any one of the similar elements having the same first reference label irrespective of the second reference label.

### 1. BRIEF DESCRIPTION OF THE DRAWINGS

FIG. 1 is a top-rear-right oblique view of a first embodiment of a horseshoe according to aspects of the present invention.

FIG. 2 is a front elevation view of the horseshoe of FIG. 1.

FIG. 3 is a left elevation view of the horseshoe of FIG. 1.

FIG. 4 is a rear elevation view of the horseshoe of FIG. 1.

FIG. 5 is a right elevation view of the horseshoe of FIG. 1.

FIG. 6 is a top plan view of the horseshoe of FIG. 1.

FIG. 7 is a bottom plan view of the horseshoe of FIG. 1.

FIG. 8 is a top-rear-right oblique view of a second embodiment of a horseshoe according to aspects of the present invention.

FIG. 9 is a front elevation view of the horseshoe of FIG. 8.

FIG. 10 is a left elevation view of the horseshoe of FIG. 8.

FIG. 11 is a rear elevation view of the horseshoe of FIG. 8.

FIG. 12 is a right elevation view of the horseshoe of FIG. 8.

FIG. 13 is a top plan view of the horseshoe of FIG. 8.

FIG. 14 is a top-left oblique view the horseshoe of FIG. 8.

FIG. 15 is a bottom-left oblique view of the horseshoe of FIG. 8.

FIG. 16 is a bottom plan view of the horseshoe of FIG. 8.

FIG. 17a is a top-rear-right oblique view of a portion of a third embodiment of a horseshoe according to aspects of the present invention.

FIG. 17b is a sectional view of the horseshoe of FIG. 17a, viewed along the cutting-plane A-A.

FIG. 18 is a top-rear-right oblique view of a portion of a fourth embodiment of a horseshoe according to aspects of the present invention.

### 2. DETAILED DESCRIPTION OF SPECIFIC EMBODIMENTS

### (a) Structure of Specific Embodiments

The structure of the invention will now be illustrated by explanation of specific, non-limiting, exemplary embodiments shown in the drawing figures and described in greater detail herein.

### (i) First Embodiment

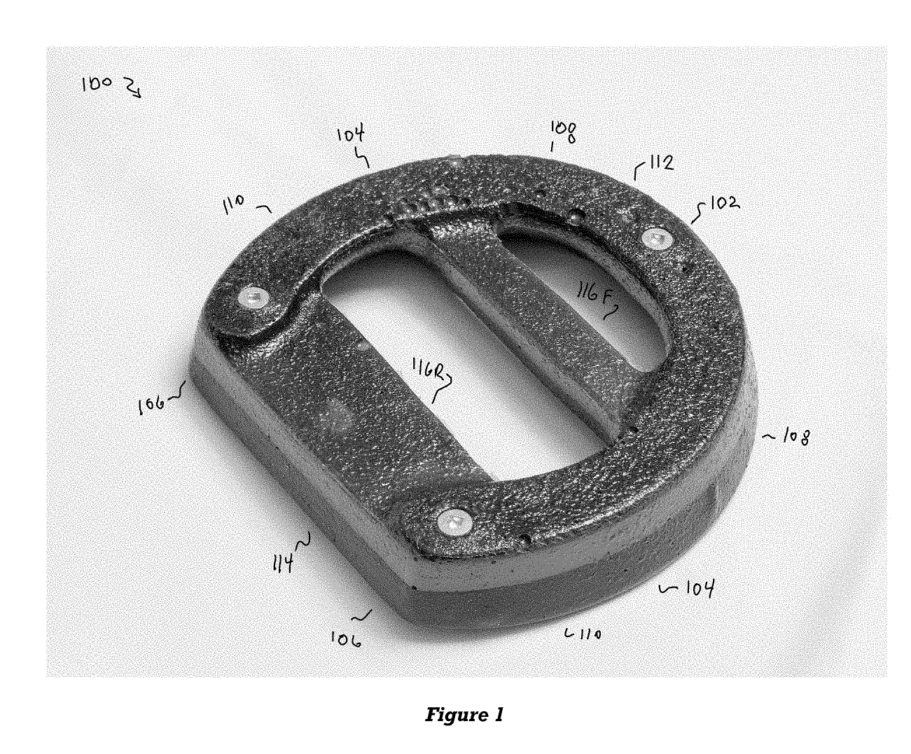

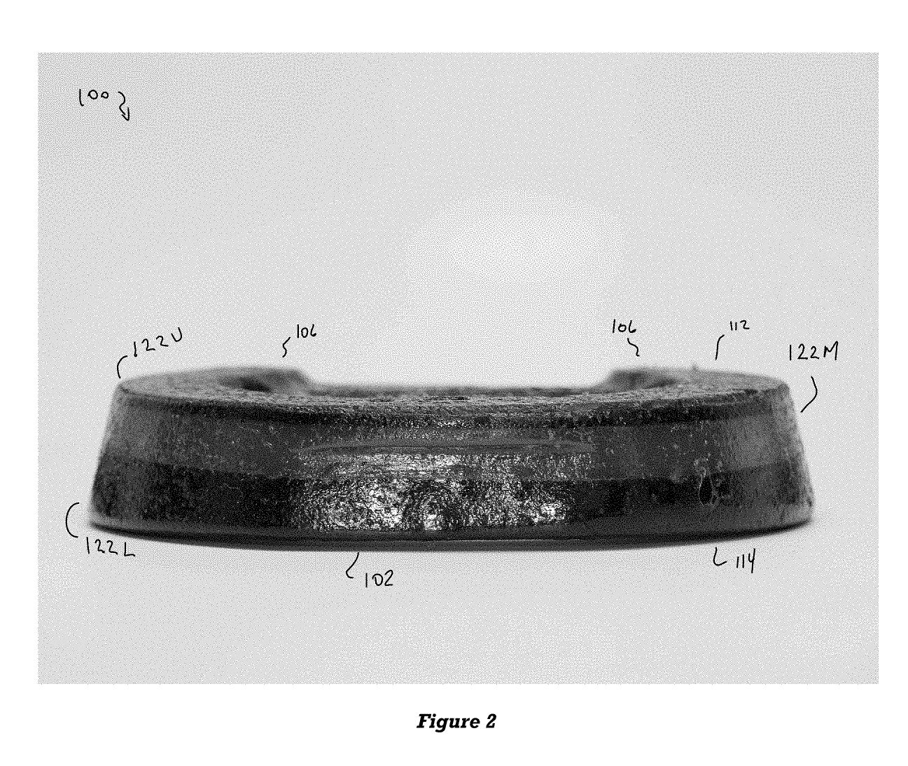

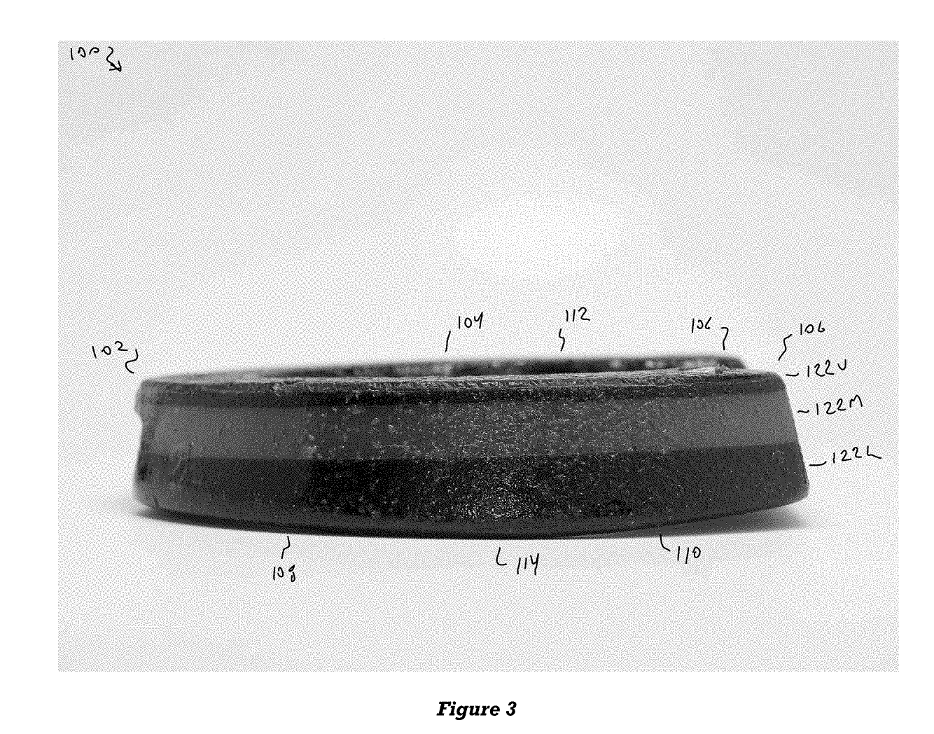

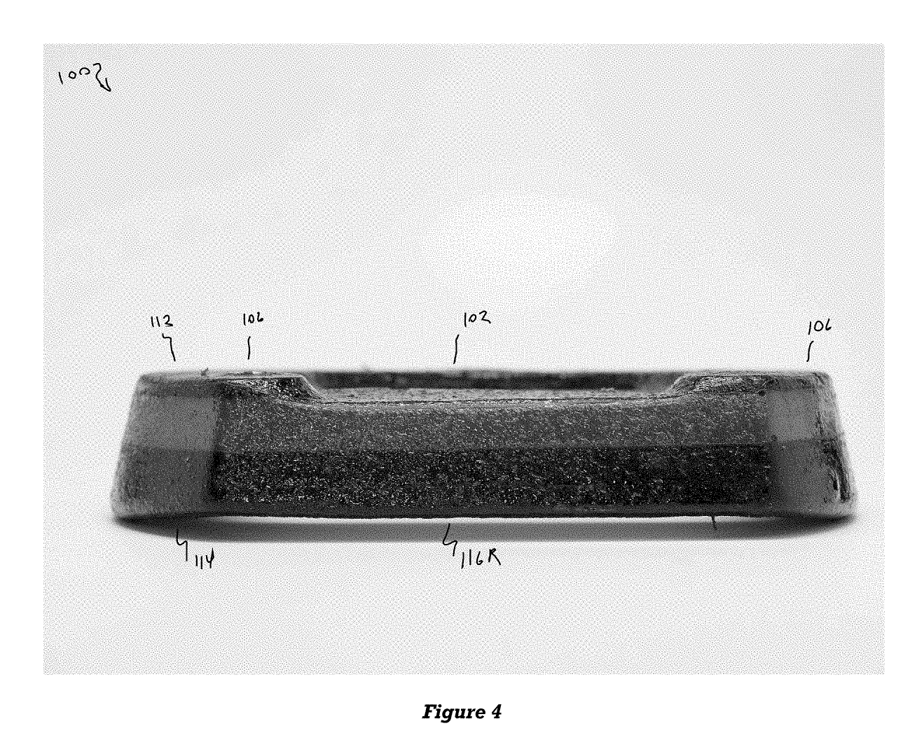

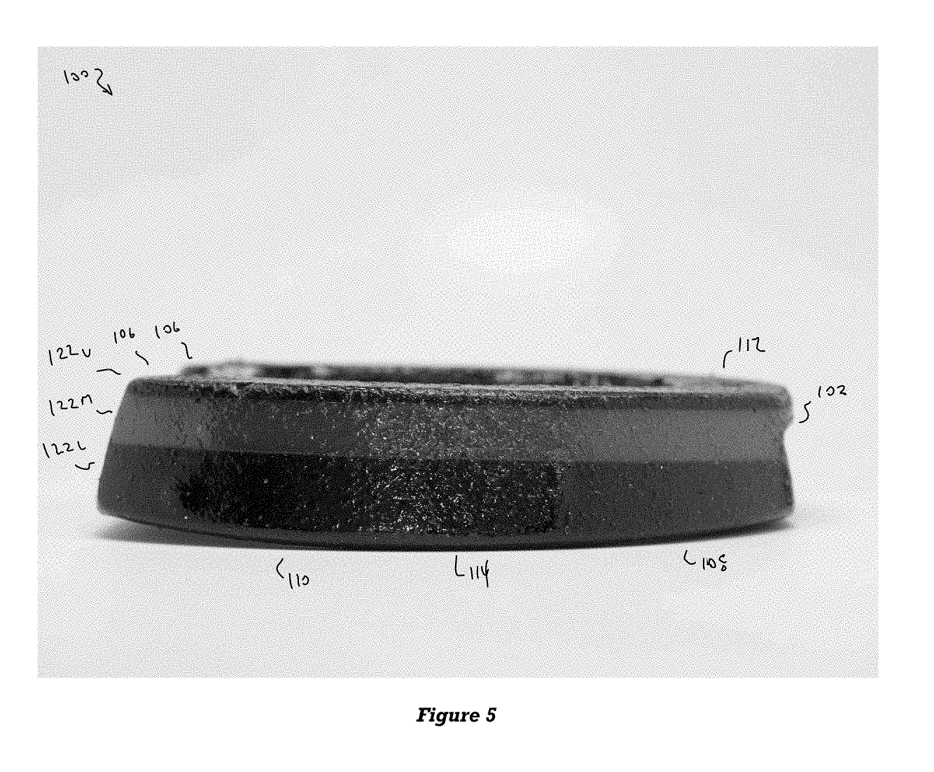

FIGS. 1-7 show a horseshoe according to a first embodiment of aspects of the present invention, generally illustrated at 100. The horseshoe 100 has a toe 102, from which extend opposing branches 104, which respectively terminate in a heel 106. Each branch 104 has a sidewall portion 108 and a quarter portion 110.

The horseshoe 100 has an upper surface 112 adapted to abut a hoof and a lower surface 114 adapted to engage the ground. When the hoof has been shod, the toe of the hoof is adjacent the toe 102 of the horseshoe 100, the sidewall of the hoof is adjacent the sidewall portion 108 of the horseshoe 100, the quarter of the hoof is adjacent the quarter portion 110 of the horseshoe 100 and the heel of the hoof is adjacent the heel 106 of the horseshoe 100.

As illustrated, the upper surface 112 may taper toward the lower surface 114 from the heel 106 toward the toe 102, for example yielding a one inch thickness between the surfaces 112, 114 at the heel 106 down to seven eighths of an inch thickness between the surfaces 112, 114 at the toe 102.

As illustrated, the lower surface 114 may be cambered between the toe 102 and the heel 106, for example at the toe 102, at the heel 106, or at both the toe 102 and the heel 106. As illustrated, the toe 102 may be notched. Those skilled in the art will appreciate that the cambering and the notching promote a heel 106 to toe 102 roll and break-over motion.

The horseshoe 100 may be fully or partially void between the opposing branches 104, as appropriate to balance the mass and strength of the horseshoe 100 and to provide access to the hoof for cleaning. In this regard, the horseshoe 100 may have one or more crossbars 116 spanning the void between the branches 104. As illustrated, a rear crossbar 116R may span between the branches 104 at their respective heels 106, and a forward crossbar 116F may span between the branches 104 at the respective junctions of their respective sidewall portions 108 and quarter portions 110, for example proximate the frog of the hoof.

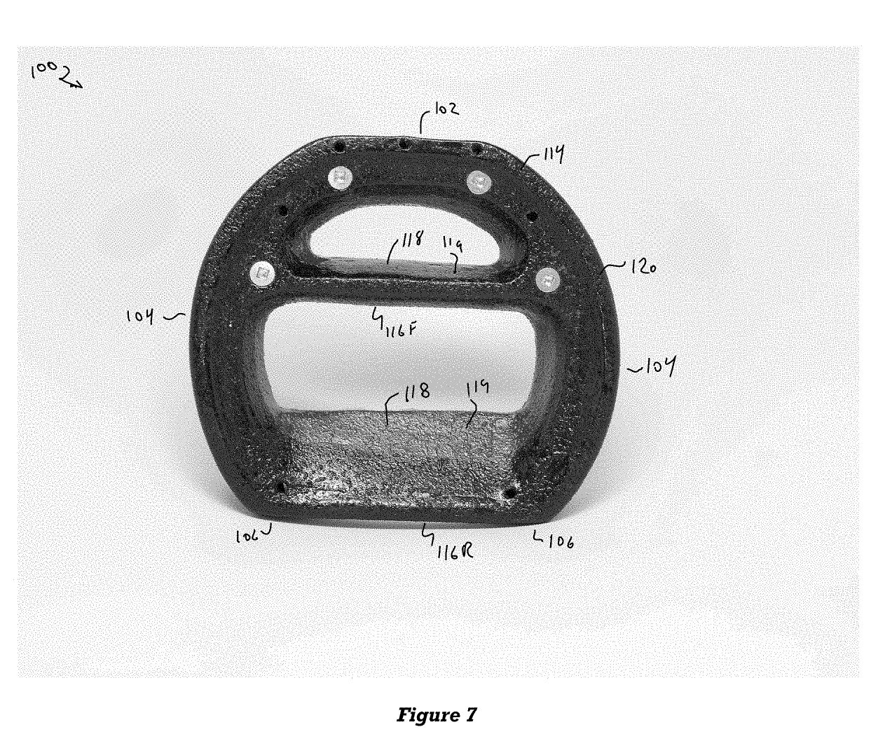

As best seen in FIG. 7, any of the one or more crossbars 116 may be configured as a slide 118 having a plowing surface 119 with a forward pitch. For example, the rear crossbar 116R may have a slide 118 with a plowing surface 119 having a forward pitch of thirty degrees to the ground and the forward crossbar 116F may have a slide 118 with a steeper plowing surface 119 having forward pitch of sixty degrees to the ground.

The lower surface 114 may include a peripheral flange 120, for example as illustrated a flange 120 that forms a fully closed perimeter. As illustrated, the flange 120 may vary in depth and/or width about this perimeter.

The horseshoe 100 may be formed from plastic or other materials having similar properties as described below. As best seen in FIGS. 1-5, the horseshoe 100 may be formed as a lamination of layers 122 of plastic, for example three layers of plastic, namely an elastic lower layer 122L formed of for example toluene diisocyanate (TDI) poly tetramethylene ether glycol (PTMEG) prepolymer 80 Shore A, an inelastic middle layer 122M formed of for example toluene diisocyanate (TDI) poly tetramethylene ether glycol (PTMEG) prepolymer 75 Shore D and an elastic upper layer 122U formed of for example toluene diisocyanate (TDI) poly tetramethylene ether glycol (PTMEG) prepolymer 80 Shore A. In this regard, the lower layer 122L may be fourth eighths of an inch thick, the middle layer 122M may be three eighths of an inch thick, and the upper layer 122U may be one eighth of an inch thick. The thickness of the lower layer 122L and the upper layer 122U may resiliently compress about thirty percent when the hoof of a horse of typical mass impacts the ground.

The lower layer 122L is thus adapted to surely engage the ground while yielding to absorb impact. The middle layer 122M is thus adapted retain the shape of the horseshoe 100 during use and to accept and reliably retain fasteners used to mount the horseshoe 100 to the hoof. The upper layer 122U is thus adapted to surely support the hoof while yielding to absorb impact, and in particular to resist impact damage to either the hoof or the middle layer 122M. This absorption may encourage horse hoofs to grow faster than when using conventional metal shoes.

### (ii) Second Embodiment

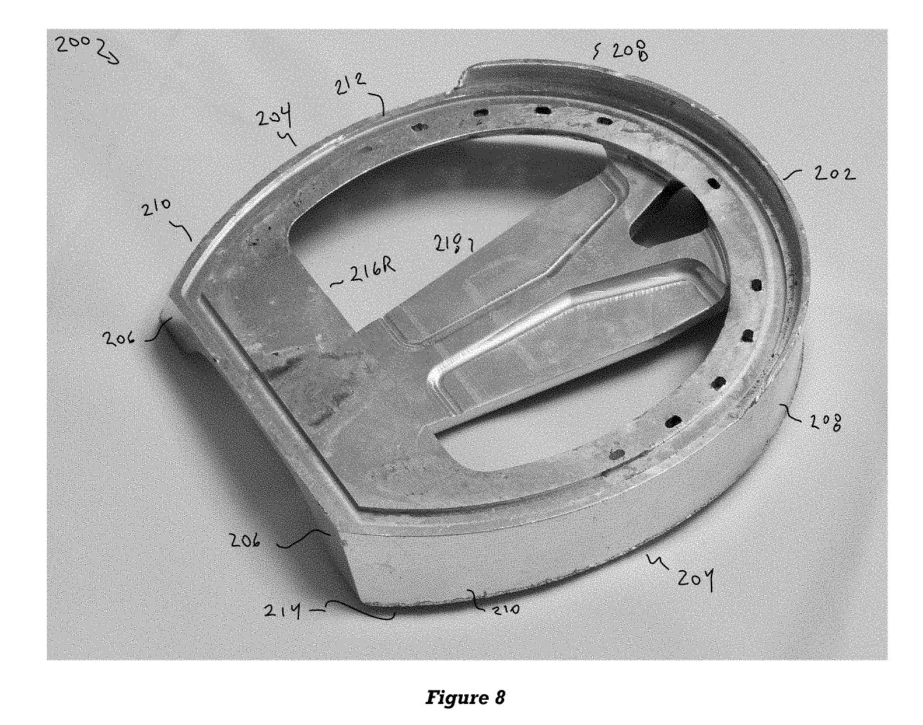

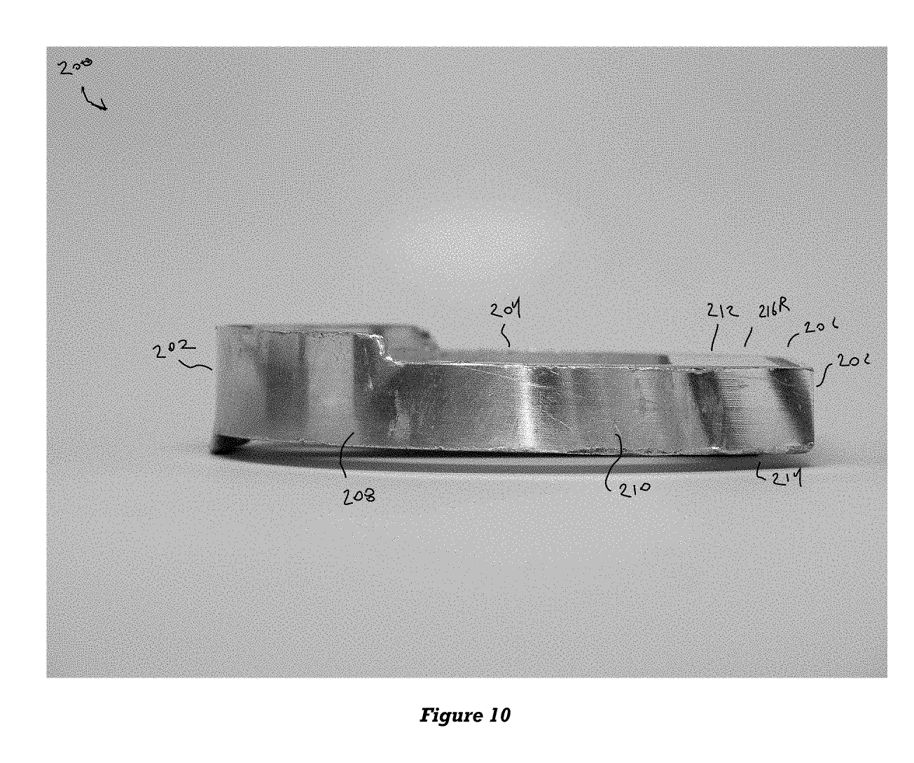

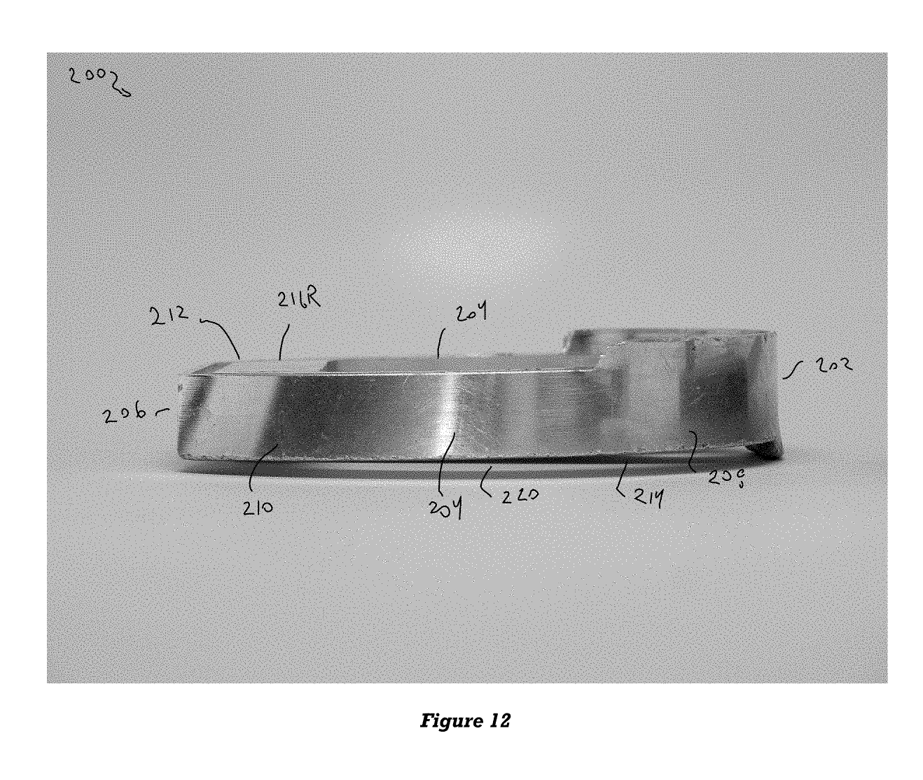

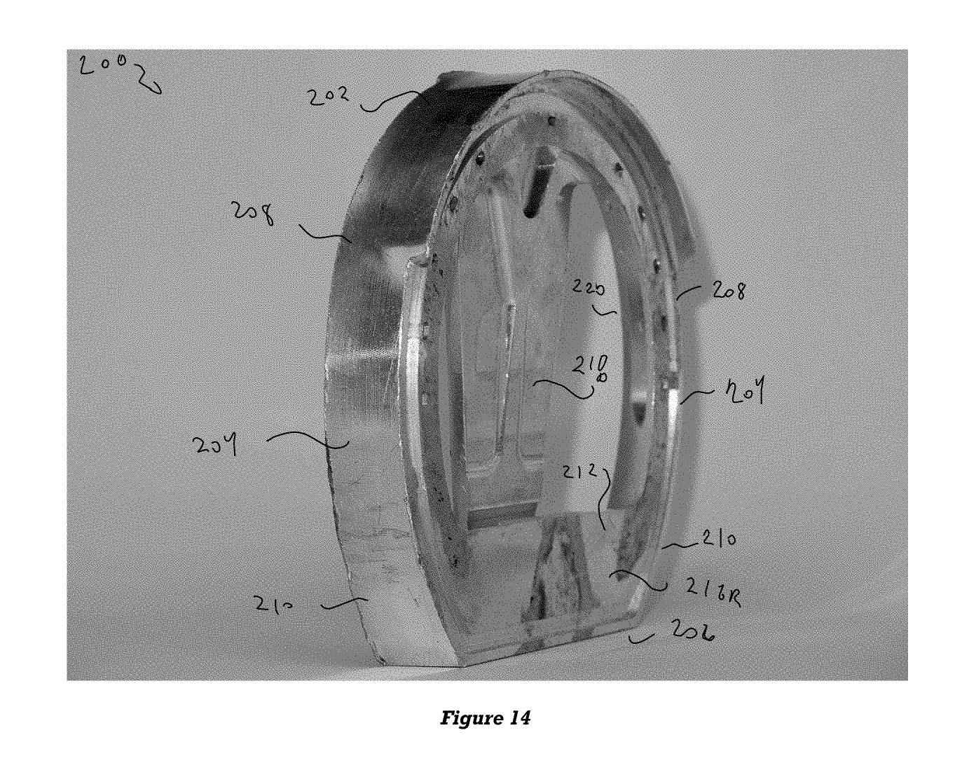

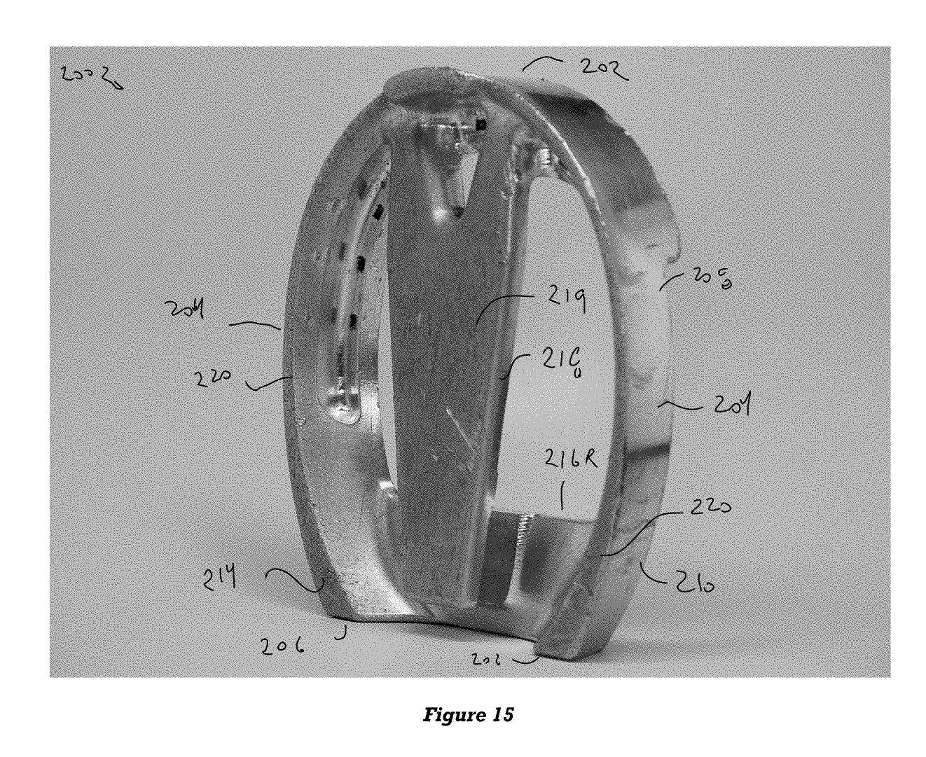

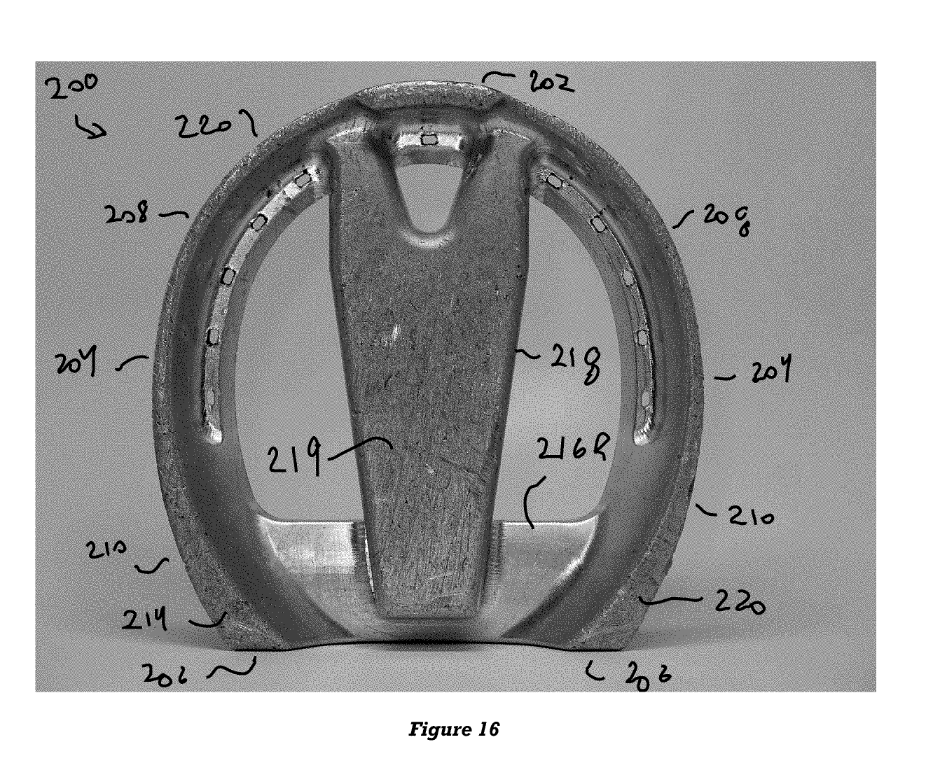

FIGS. 8-16 show a horseshoe according to a second embodiment of aspects of the present invention, generally illustrated at 200.

The horseshoe 200 has a toe 202, from which extend opposing branches 204, which respectively terminate in a heel 206. Each branch 204 has a sidewall portion 208 and a quarter portion 210.

The horseshoe 200 has an upper surface 212 adapted to abut a hoof and a lower surface 214 adapted to engage the ground. When the hoof has been shod, the toe of the hoof is adjacent the toe 202 of the horseshoe 200, the sidewall of the hoof is adjacent the sidewall portion 208 of the horseshoe 200, and the quarter of the hoof is adjacent the quarter portion 210 of the horseshoe 200.

As illustrated, the upper surface 212 may taper toward the lower surface 214 from the heel 206 toward the toe 202, for example yielding a one inch thickness between the surfaces 212, 214 at the heel 206 down to seven eighths of an inch thickness between the surfaces 212, 214 at the toe 202.

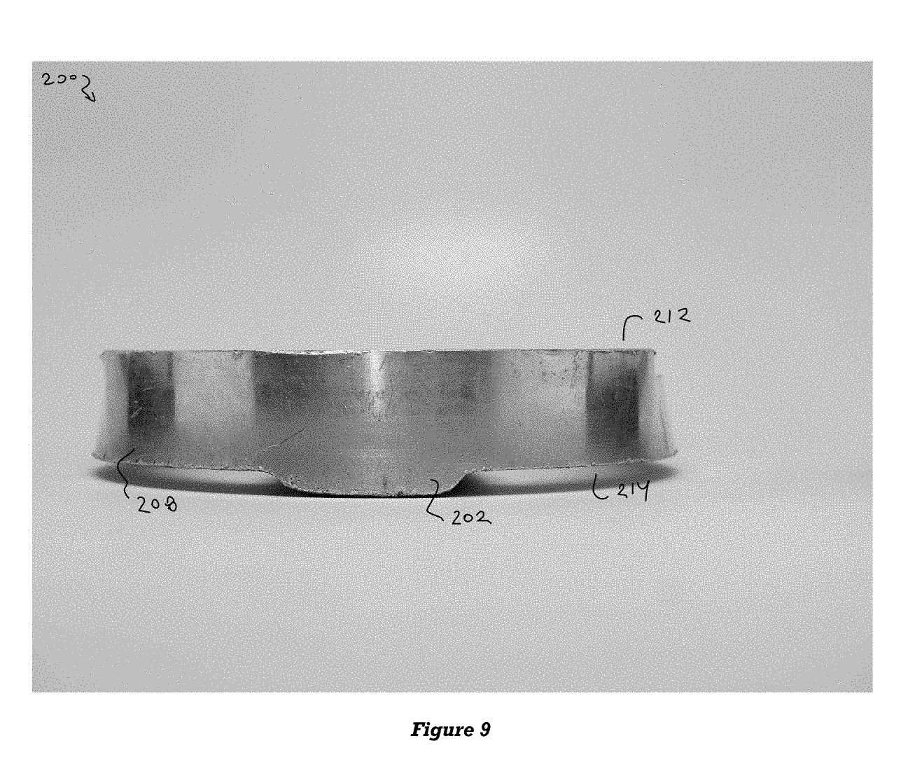

As illustrated, the lower surface 214 may be cambered between the toe 202 and the heel 206, for example at the toe 202, at the heel 206, or at both the toe 202 and the heel 206. As illustrated, the toe 202 may be bossed. Those skilled in the art will appreciate that the cambering promotes a heel 206 to toe 202 roll, and the bossing, if downward (as best seen in FIGS. 9, 10 and 12), surely engages the ground and promotes break-over motion and if upward (as best seen in FIGS. 8, 10-12), surely engages the toe of the hoof.

The horseshoe 200 may be fully or partially void between the opposing branches 204, as appropriate to balance the mass and strength of the horseshoe 200 and to provide access to the hoof for cleaning. In this regard, the horseshoe may have one or more crossbars 216 spanning the void between the branches 204, as illustrated, a rear crossbar 216R may span between the branches 204 at their respective heels 206.

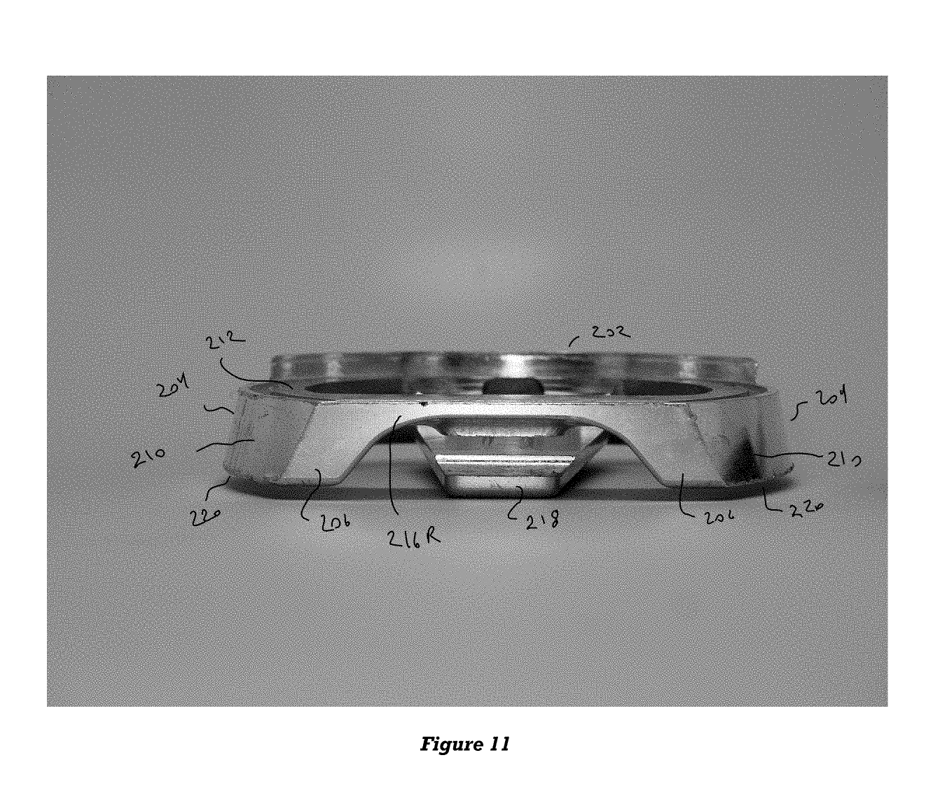

As best seen in FIGS. 11, 13-16, the horseshoe 200 may include a slide 218 having a plowing surface 219 with a forward pitch, for example a pitch of six degrees to ground. Those skilled in the art will recognize that the slide 218, as illustrated, may be a cantilever, such the pitch may change under load.

The lower surface 214 may include a peripheral flange 220, for example as illustrated a flange 220 that forms partially closed perimeter that breaches between the heels 206 of the respective branches 204. As illustrated, the flange 220 may vary in depth and/or width about this perimeter.

The horseshoe 200 may be formed from tempered aluminum, magnesium or similar materials or materials having similar properties.

### (iii) Third Embodiment

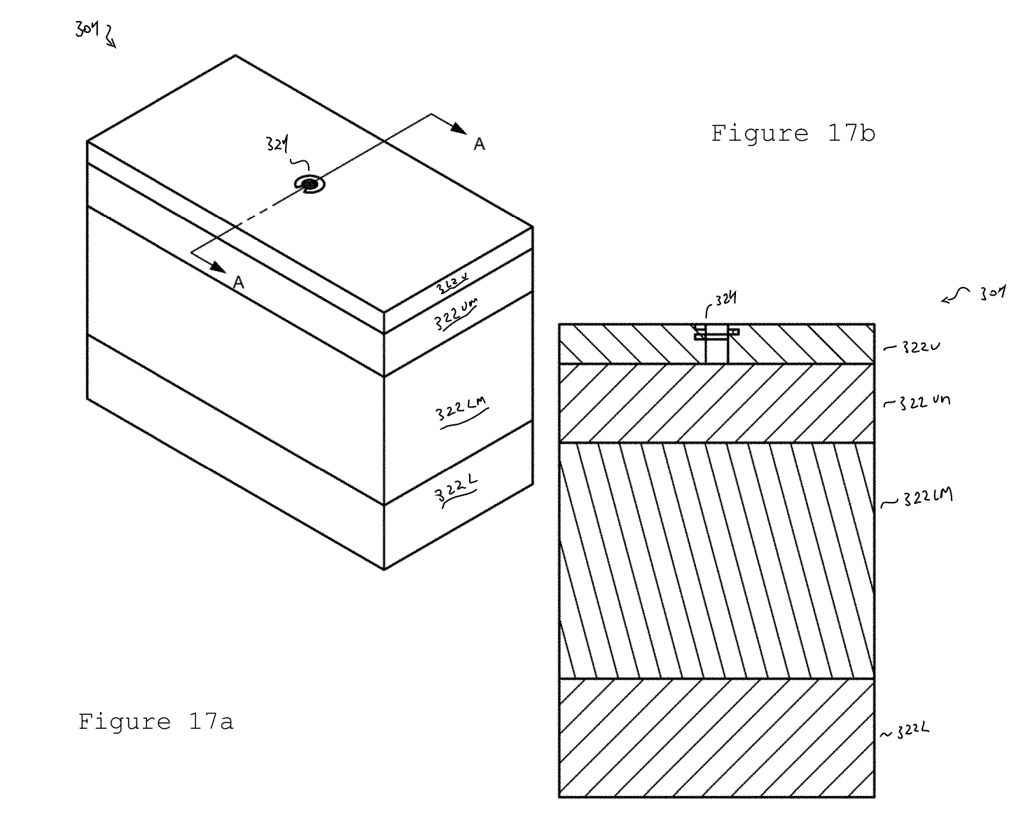

FIGS. 17a and 17b show a portion of a branch 304 of horseshoe according to a third embodiment of aspects of the present invention, which has similarities to both the first embodiment horseshoe 100 and the second embodiment horseshoe 200.

The third embodiment horseshoe is formed as a lamination of layers 322, for example four layers, namely a lower layer 322L formed of metal, for example tempered aluminum or magnesium, an elastic lower middle layer 322LM formed of for example toluene diisocyanate (TDI) poly tetramethylene ether glycol (PTMEG) prepolymer 80 Shore A, an inelastic upper middle layer 322UM formed of for example toluene diisocyanate (TDI) poly tetramethylene ether glycol (PTMEG) prepolymer 75 Shore D, and an elastic upper layer 322U formed of for example toluene diisocyanate (TDI) poly tetramethylene ether glycol (PTMEG) prepolymer 80 Shore A. The upper layer 322U may contain voids circumscribed by coil springs 324, for example lock washers, to resiliently retain fasteners for mounting the third embodiment horseshoe onto a hoof of a horse.

In this regard, the lower layer 322L may be three eighths of an inch thick, the lower middle layer 322LM may be six eighths of an inch thick, the upper middle layer 322UM may be two eighths of an inch thick, and the upper layer 322U may be one eighth of an inch thick. The thickness of the lower middle layer 322LM and the upper layer 322U may resiliently compress about thirty percent when the hoof of a horse of typical mass impacts the ground.

Those skilled in the art will recognize that this third embodiment horseshoe is in ways akin to the first embodiment horseshoe 100 mounted atop the second embodiment horseshoe 200 and having characteristics of each. In this regard, the lower layer 322L is thus adapted to surely engage the ground and the upper layer 322U is thus adapted to surely support the hoof while yielding to absorb impact, and in particular to resist impact damage to either the hoof or the layers 322 below.

### (iv) Fourth Embodiment

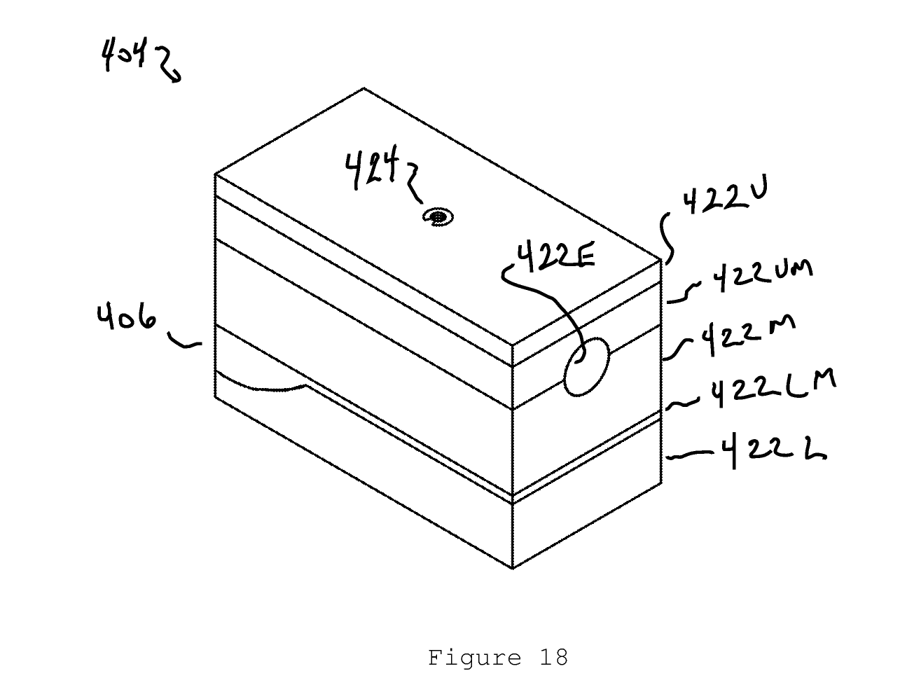

FIG. 18 shows a portion of a branch 404 of a horseshoe according to a fourth embodiment of aspects of the present invention, which has similarities to the third embodiment.

The fourth embodiment horseshoe is formed as a lamination of layers 422, for example six layers, namely a lower layer 422L formed of metal, for example tempered aluminum or magnesium, an elastic middle layer 422M formed of for example toluene diisocyanate (TDI) poly tetramethylene ether glycol (PTMEG) prepolymer 80 Shore A, an elastic adhesive bonding lower middle layer 422LM to bond the lower layer 422L to the middle layer 422M, that may for example be thicker in some portions than others, for example at extremities such as the heal 406 or the toe, an inelastic upper middle layer 422UM formed of for example toluene diisocyanate (TDI) poly tetramethylene ether glycol (PTMEG) prepolymer 75 Shore D, an elastic upper layer 422U formed of for example toluene diisocyanate (TDI) poly tetramethylene ether glycol (PTMEG) prepolymer 80 Shore A, and an elastic embedded layer 422E, for example an inflated latex tube, embedded between a portion of the upper middle layer 422UM and the middle layer 422M. The upper layer 322U may contain voids circumscribed by coil springs 324, for example lock washers, to resiliently retain fasteners for mounting the third embodiment horseshoe onto a hoof of a horse.

In this regard, the lower layer 422L may be three eighths of an inch thick, the middle layer 422M may be three eighths of an inch thick, the upper middle layer 422UM may be two eighths of an inch thick, and the upper layer 422U may be one eighth of an inch thick. The thickness of the middle layer 422M and the upper layer 422U may resiliently compress about thirty percent when the hoof of a horse of typical mass impacts the ground.

In general, regarding any horseshoe embodiment, the characteristics of the horseshoe selected for use may vary depending, for example, on the type of horse (thoroughbred versus standardbred), the type of activity (jockey racing versus sulky racing versus general work), or the position on the horse (front hoof versus rear hoof). Thus for example, a horseshoe fit to a front hoof might have greater taper between the heel and toe and a horseshoe fit to a rear hoof might have no such taper, so as to encourage the front hoof to roll and break-over while resisting such motion in the rear hoof.

### (b) Operation of Specific Embodiments

### (i) First Embodiment

FIGS. 1-7 show a first embodiment of a horseshoe 100 according to aspects of the present invention, the operation of which will now be described.

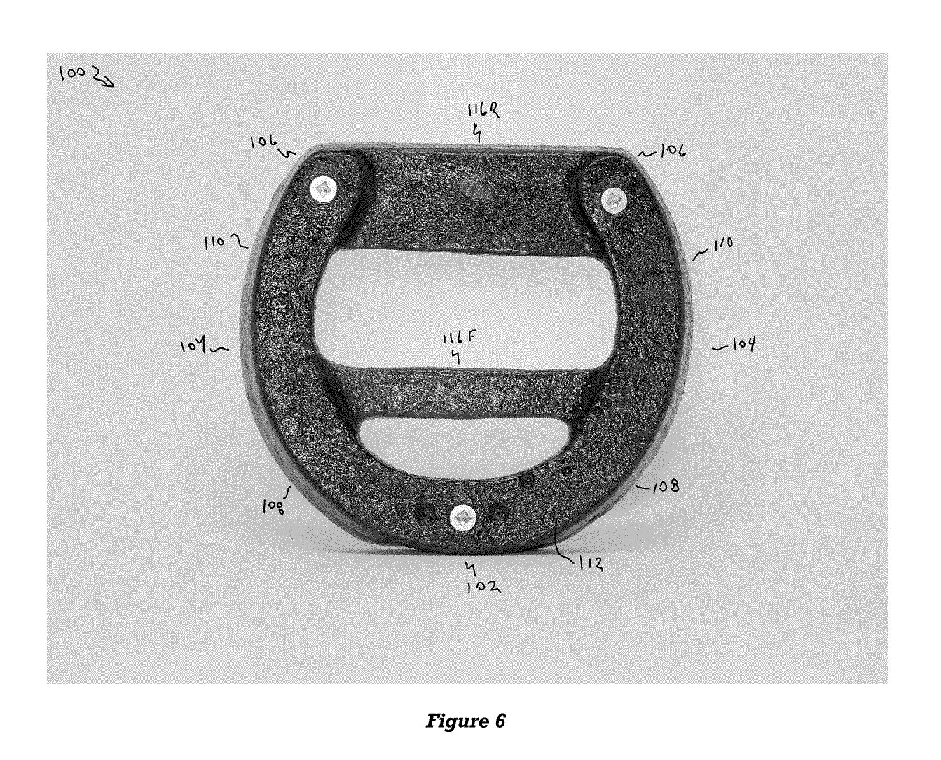

As best seen in FIGS. 1 and 6, a farrier would shape the horseshoe 100 and a horse's hoof (not shown) to yield good abutting contact between the upper surface 112 of the horseshoe 100 and the bottom of the horse's hoof, and also alignment of the toe, sidewall and quarter of the hoof with the toe 102, sidewall portion 108 and quarter portion 110 of the horseshoe 100 respectively. The horseshoe 100 might be manufactured in an assortment of common sizes and shapes to reduce the amount of custom shaping needed to yield this result. As best seen in FIG. 7, the farrier would then fasten the horseshoe 100 to the hoof by applying fasteners through the lower surface 114 of the horseshoe (either in preformed holes as illustrated or otherwise) and on into the hoof of the horse. The farrier would then perform final shaping of the horseshoe 100 and the hoof for final fit. Between fittings, the farrier might also shape the horseshoe 100 and the hoof to maintain good fit.

In use, as the horse's hoof approaches the ground, the peripheral flange 120 on the lower surface 114 of the horseshoe 100 encourages good traction with the ground. The plowing surface 119 of any slides 118, for example as embodied in crossbars 116, also encourage good traction.

If the horseshoe 100 has a taper between the upper surface 112 and the lower surface 114, then this orientation can better align the lower surface 114 with the ground and also encourage the hoof to break-over. This break-over is also encouraged if the toe 102 is notched and/or the bottom surface 114 is cambered.

### (ii) Second Embodiment

FIGS. 8-16 show a second embodiment of a horseshoe 200 according to aspects of the present invention, the operation of which will now be described.

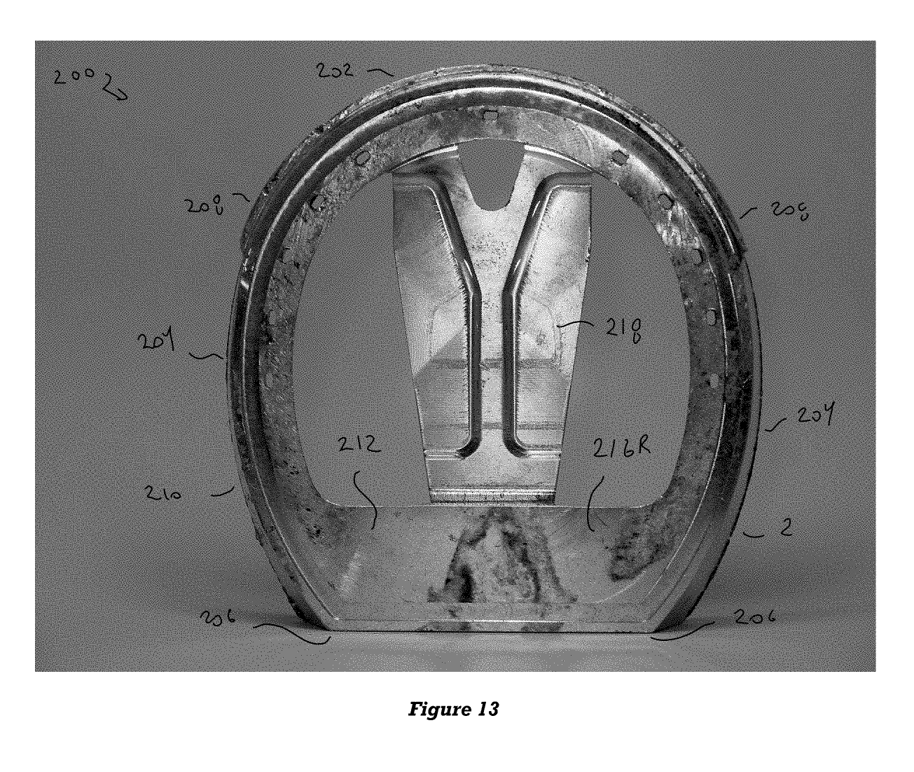

As best seen in FIGS. 8 and 13, a farrier would shape a horse's hoof (not shown) to yield good abutting contact between the upper surface 212 of the horseshoe 200 and the bottom of the horse's hoof, and also alignment of the toe, sidewall and quarter of the hoof with the toe 202, sidewall portion 208 and quarter portion 210 of the horseshoe 200 respectively. If the toe 202 includes upward bossing, that can also help to mate the horseshoe 200 with the hoof.

The horseshoe 200 might be manufactured in an assortment of common sizes and shapes to reduce the amount of custom shaping needed to yield this result. The farrier would then fasten the horseshoe 100 to the hoof by applying fasteners through the lower surface 114 of the horseshoe in preformed holes as illustrated and on into the hoof of the horse. The farrier would then perform final shaping of the hoof for final fit. Between fittings, the farrier might also shape the hoof to maintain good fit.

In use, as the horse's hoof approaches the ground, the peripheral flange 220 on the lower surface 214 of the horseshoe 200 encourages good traction with the ground. The plowing surface 219 of the slide 218 also encourages good traction, as does downward bossing on the toe 202 if such exists. Furthermore, the slide 218, being cantilevered, can resiliently deform under stress to absorb impact forces.

If the horseshoe 200 has a taper between the upper surface 212 and the lower surface 214, then this orientation can better align the lower surface 214 with the ground and also encourage the hoof to break-over. This break-over is also encouraged if the bottom surface 214 is cambered.

### (iii) Third Embodiment

FIGS. 17a and 17b show a portion of a third embodiment of a horseshoe according to aspects of the present invention. Those skilled in the art will recognize that this third embodiment, having both plastic and metal layers 322, would operate in a hybrid manner, sharing some operating characteristics with the first embodiment horseshoe 100 and other operating characteristics with the second embodiment horseshoe 200.

For example, the upper layer 322U, being plastic, might be shaped during initial fitting or maintenance of the horseshoe.

### (iv) Fourth Embodiment

FIG. 18 shows a portion of a third embodiment of a horseshoe according to aspects of the present invention. Those skilled in the art will recognize that the fourth embodiment will operate similarly to the third embodiment, but with extra compression provided by the lower middle layer 422LM and the embedded layer 422E.

### (c) Description Summary

Thus, it will be seen from the foregoing embodiments and examples that there has been described a horseshoe with new and inventive aspects, including having a toe end, a heel end opposite the toe end, a top surface that spans between the heel end and the toe end, and a bottom surface that spans between the heel end and the toe end, wherein the top surface tapers toward the bottom surface from the heel end to the toe end.

While specific embodiments of the invention have been described and illustrated, such embodiments should be considered illustrative of the invention only and not as limiting the invention. In particular, all quantities described have been determined empirically and those skilled in the art might well expect a wide range of values surrounding those described to provide similarly beneficial results.

It will be understood by those skilled in the art that various changes, modifications and substitutions can be made to the foregoing embodiments without departing from the principle and scope of the invention.

1. An apparatus, operable as a horseshoe, comprising:
a. a toe end,
b. a heel end opposite the toe end,
c. a top surface that spans between the heel end and the toe end, and
d. a bottom surface that spans between the heel end and the toe end,
wherein the top surface tapers toward the bottom surface from the heel end to the toe end.

2. An apparatus as claimed in claim 1, wherein the separation between the top surface and the bottom surface at the heel end is 1″.

3. An apparatus as claimed in claim 2, wherein the taper is ⅛″.

4. An apparatus as claimed in claim 1, wherein the top surface encloses a void between the heel end and the toe end.

5. An apparatus as claimed in claim 4, further comprising a reinforcing crossbar.

6. An apparatus as claimed in claim 5, wherein the crossbar is located at the heel end.

7. An apparatus as claimed in claim 5, wherein the crossbar is located between the toe end and the heal end and divides the void.

8. An apparatus as claimed in claim 1, wherein the bottom surface is a peripheral flange.

9. An apparatus as claimed in claim 8, wherein the peripheral flange is closed.

10. An apparatus as claimed in claim 9, wherein the peripheral flange includes a spur at the heel end.

11. An apparatus as claimed in claim 10, wherein the width of the peripheral flange tapers from the heel end to the toe end.

12. An apparatus as claimed in claim 11, wherein the width of the peripheral flange tapers from ¾″ at the heel end to ⅛″ at the toe end.

13. An apparatus as claimed in claim 8, wherein the peripheral flange is notched at the toe end.

14. An apparatus as claimed in claim 10, further comprising a sprung lever extending downward from the toe end to the heel end within the peripheral flange.

15. An apparatus as claimed in claim 1, further comprising a toe flange extending vertically from the toe end.

16. An apparatus as claimed in claim 15, wherein the toe flange extends upward and is adapted to receive a hoof.

17. An apparatus as claimed in claim 16, wherein the toe flange extends downward and is adapted to engage the ground.

18. An apparatus as claimed in claim 1, wherein the bottom surface is cambered at the toe end.

19. An apparatus as claimed in claim 1, wherein the apparatus is formed from at least one of:
a. magnesium,
b. tempered aluminum, and
c. plastic.

20. An apparatus as claimed in claim 19, wherein the plastic is at least one of:
a. toluene diisocyanate (TDI) poly tetramethylene ether glycol (PTMEG) prepolymer 80 Shore A, and
b. toluene diisocyanate (TDI) poly tetramethylene ether glycol (PTMEG) prepolymer 75 Shore D.

21. An apparatus as claimed in claim 19, wherein the apparatus is formed as a lamination of layers.

22. An apparatus as claimed in claim 21, wherein the apparatus is formed as a lamination of a top layer, at least one middle layer and a bottom layer, each layer extending between the heel end and the toe end.

23. An apparatus as claimed in claim 22, wherein the top layer is adapted to support a hoof.

24. An apparatus as claimed in claim 22, wherein the at least one middle layer is adapted to accept and retain nails.

25. An apparatus as claimed in claim 22, wherein the bottom layer is adapted to engage the ground.

26. An apparatus as claimed in claim 22, wherein the top and bottom layers are elastically compressible between 25 and 35 percent.

27. An apparatus as claimed in claim 26, wherein:
a. the top layer is ⅛ inch thick,
b. the at least one middle layer is ⅜ inch, and
c. the bottom layer is ½ inch thick.
